(19) United States
(12) Patent Application Publication
(10) Pub. No.: US 2006/0222864 A1
(43) Pub. Date: Oct. 5, 2006

(54) Method of forming boron-doped and fluorine-doped organosilicate glass films

(76) Inventors: George A. Antonelli, Portland, OR (US); Mandayam A. Sriram, Beaverton, OR (US); Michael D. Goodner, Hillsboro, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/096,596

(22) Filed: Mar. 31, 2005

(51) Int. Cl. B32B 9/04; B32B 13/04

(52) U.S. Cl. 428/446; 427/249.1

(57) ABSTRACT

An embodiment of the invention is a method of forming a low-k carbon doped oxide dielectric material with improved mechanical properties. An embodiment incorporates a precursor containing a fluorinated organic silane, an alkylborane, or an alkoxyborane with a low-k carbon doped oxide dielectric material precursor during chemical vapor deposition to accomplish the mechanical improvement

### FIELD

Embodiments of the invention relate to a method for forming a doped oxide dielectric film and more particularly to forming boron-doped and fluorine-doped organosilicate glass low-k dielectric films.

### BACKGROUND

The semiconductor industry is currently experiencing a paradigm shift to interlayer dielectric materials that have dielectric constants lower than that of silicon dioxide (“low-k dielectrics”). There are myriad choices for the dielectric material and deposition process. An early forerunner in low-k dielectrics was fluorine doped silicon oxide, or fluorosilicate glass (“FSG”). The appeal was that an FSG film could be deposited in a similar manner as the undoped oxide film, allowing the use of the same processing techniques and machines. Furthermore, the mechanical properties are also comparable to silicon dioxide (e.g., Young's modulus at least 50% that of SiO₂), allowing facile integration using conventional processing schemes. However, only a small amount of fluorine (5-8% atomically) can be incorporated into the SiO₂ matrix in a stable manner, limiting the extendibility of FSG films as the dielectric constant of optimized fluorinated silicon dioxide is only marginally lower (3.3-3.5) than that of undoped silicon dioxide (3.9-4.2).

Another popular low-k dielectric material is organosilicate glass (“OSG”), also known as carbon doped oxide (“CDO”). Generally speaking, the CDO films have an Si_{w}CₓO_{y}H_{z} structure wherein the tetravalent silicon has a variety of organic group substitutions. The most common substitution is a methyl (CH₃) group provided by an organic precursor gas like trimethylsilane or tetramethlysilane (“3MS” and “4MS” respectively). For CDO, the amorphous SiO₂ network is sporadically interrupted by the organic group, decreasing the density of the film. Like with FSG, the lower density of CDO compared to undoped SiO₂ decreases the dielectric constant. However, also similar to FSG, CDO presents certain thermal and mechanical difficulties to current semiconductor processing techniques.

In particular, formation of low-k PECVD-deposited CDO films having a dielectric constant less than approximately 2.8 to 3.0 requires a significantly reduced film density, which is generally accomplished by generating porosity in the film. Reducing the film density and introducing porosity degrades the mechanical properties of the film (to less than 20% that of SiO₂), which has resulted in no films exhibiting a dielectric constant less than 2.8 being proven to be commercially viable for high volume manufacturing.

As an alternative, to avoid damage during subsequent processing steps some schemes call for processing the dielectrics before generating porosity when the mechanical properties are still high. However, introducing the porosity in the dielectric material after interconnect formation still leaves a weakened dielectric film that can be damaged during subsequent packaging and assembly steps.

### BRIEF DESCRIPTION OF THE DRAWINGS

FIG. 1: illustration of a graph representing a relationship between dielectric constant and mechanical properties for CDO films.

FIG. 2: illustration of the chemical structure of CDO precursors dimethyldimethoxysilane (“DMDMOS”) and diethoxymethylsilane (“DEMS”)

FIG. 3: illustration of the chemical structure of boron precursors triethoxyborane (“TEOB”) and triethylborane (“TEB”)

FIG. 4: illustration of the general chemical structure of two fluorinated organic silane precursors

FIG. 5: illustration of fluorinated organic silane precursors trimethyl-(trifluoromethyl)silane, fluorotrimethylsilane, and fluorotriethoxysilane

FIG. 6: illustration of an apparatus to deposit boron-doped CDO

FIG. 7: illustration of an apparatus to deposit fluorine-doped CDO

FIG. 8: illustration of a CDO deposition process flow incorporating an additive precursor

### DETAILED DESCRIPTION

Described below are numerous embodiments for forming thin film interlayer dielectric materials having improved mechanical properties or dielectric constant using boron-containing and fluorine-containing precursors (herein referred to also as “additives”) in conjunction with typical CDO precursors during standard CDO deposition processes. In the embodiments, the precursors provide a low-k dielectric material with higher mechanical strength (as characterized by elastic modulus, hardness and cohesive strength) relative to dielectric constant, either by increasing the mechanical properties of the film while maintaining a low dielectric constant or by decreasing the dielectric constant while maintaining the mechanical properties. Reference will now be made in detail to a description of these embodiments as illustrated in the drawings. While the embodiments will be described in connection with these drawings, there is no intent to limit them to drawings disclosed herein. On the contrary, the intent is to cover all alternatives, modifications, and equivalents within the spirit and scope of the described embodiments as defined by the accompanying claims.

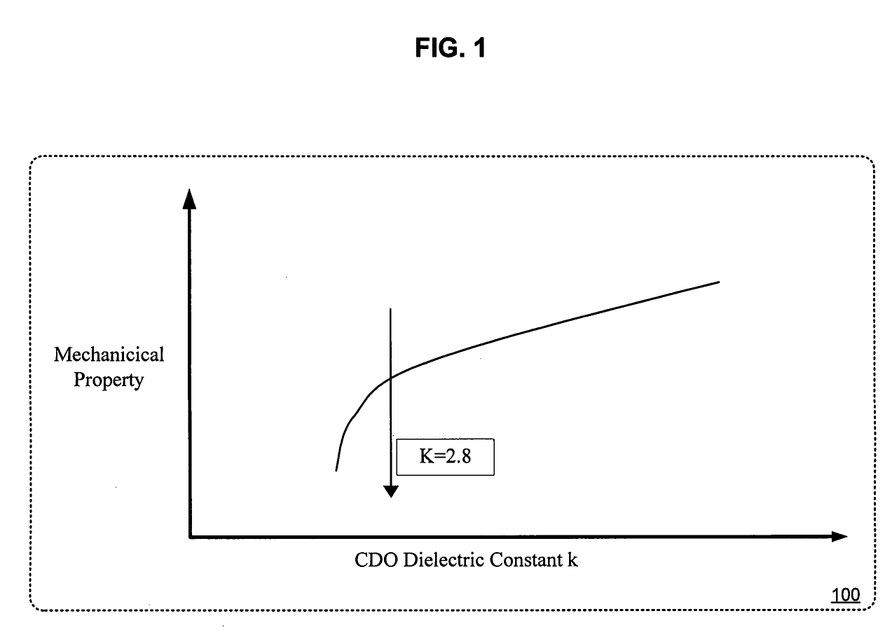

CDO dielectric materials have traditionally included CH₃ (methyl) groups to lower the density and, at high methyl group loadings, to incorporate pores in the SiO₂ matrix, each subsequently decreasing the dielectric constant of the material. The lowered density and increased porosity of the dielectric material, however, degrade the dielectric material's mechanical stability. A traditional CDO film incorporating methyl groups with a dielectric constant of approximately 3, for example, has adequate mechanical stability to survive standard semiconductor processing steps. However, increasing the methyl group loading to further lower the dielectric constant to a technical target of approximately 2.7 degrades the mechanical stability to an extent that the dielectric material becomes incompatible with the rigors of semiconductor fabrication processes. FIG. 1 is a graph 100 that illustrates a traditional relationship between CDO dielectric constant and mechanical properties. As the CDO dielectric constant decreases, the mechanical properties decrease more rapidly. More specifically, as the dielectric constant decreases beyond approximately 2.8, there is a sharp drop in mechanical property indicators such as elastic modulus, hardness and cohesive strength rendering the CDO substantially commercially impracticable when formed with a dielectric constant below approximately 2.8.

The approaches of embodiments described below are to either incorporate inorganic finctionalities as strengthening additives in addition to or in lieu of methyl groups into the SiO₂ (or CDO for the embodiments including carbon) matrix to achieve improved mechanical stability while maintaining a low dielectric constant, or to incorporate inorganic finctionalities as a means to reduce the dielectric constant without impacting the mechanical properties of the film. Embodiments include boron or fluorine in the CDO matrix and will be explained in turn.

As introduced, an embodiment includes boron in the SiO₂ molecular network. The addition of boron disrupts the molecular network in SiO₂ as silicon is a tetravalent atom, bonding to four other atoms (usually oxygen or carbon, although in some cases hydrogen or other silicon atoms), while boron is a trivalent atom and bonds to three other atoms (usually oxygen or carbon). This bonding scheme causes the SiO₂ network to be disrupted, introducing microporosity at the molecular level (i.e., pores less than 2 nm diameter) while maintaining a high bonding density that provides bulk mechanical strength. This contrasts to the microporosity and mesoporosity (i.e., pores greater than 2 nm diameter) introduced by the addition of methyl groups. Methyl groups attach to the SiO₂ matrix at only one point providing significant porosity; however the methyl group porosity decreases the bond density significantly. In another embodiment, both boron and carbon (e.g., carbon as provided by methyl groups in CDO) may be incorporated simultaneously, providing the benefits of the increased bond density from the boron and the increased porosity from the methyl groups.

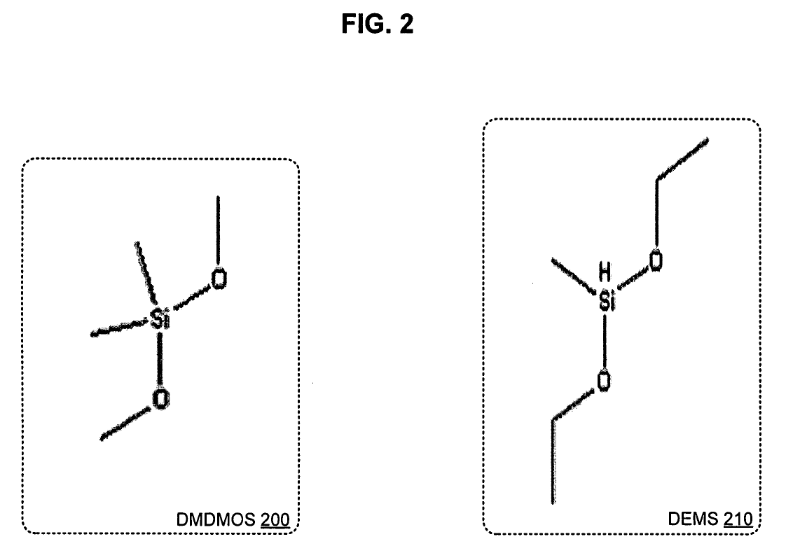

More specifically, in an embodiment the addition of an alkyl- or alkoxyborane to a standard CDO precursor such as DMDMOS or DEMS (as illustrated by DMDMOS 200 and DEMS 210 in FIG. 2) will lead to the incorporation of boron into the dielectric film. The use of an alkoxyborane such as triethoxyborane (TEOB, also known as triethylborate) in an embodiment versus other boron containing precursors increases the probability that the boron incorporates into the CDO network as the boron is initially bonded to three oxygen atoms in the TEOB precursor that can in turn readily bond to three silicon atoms. Once substantially included, the boron will create an SP² hybridized component to the Sp³ hybridized CDO network. In this way, the boron will enlarge the already present open space in the CDO network thereby lowering its density and dielectric constant while maintaining chemical bonding to neighboring Si atoms through B—O—Si linkages. Further, in an embodiment, the pore size created by the boron in the CDO is smaller than the approximately between 1.5 nanometer and 2.5 nanometer pores currently prevalent in dielectric materials with dielectric constants less than 2.8. The smaller pores in the boron doped CDO will further have a lower probability interconnection. The smaller pores of an embodiment are formed due to a re-arrangement of the bonding structure within the CDO network rather than bond breakage as is the case in many present day low-k dielectric materials. The result is that the CDO of an embodiment exhibits improved mechanical strength and stability for a given low dielectric constant.

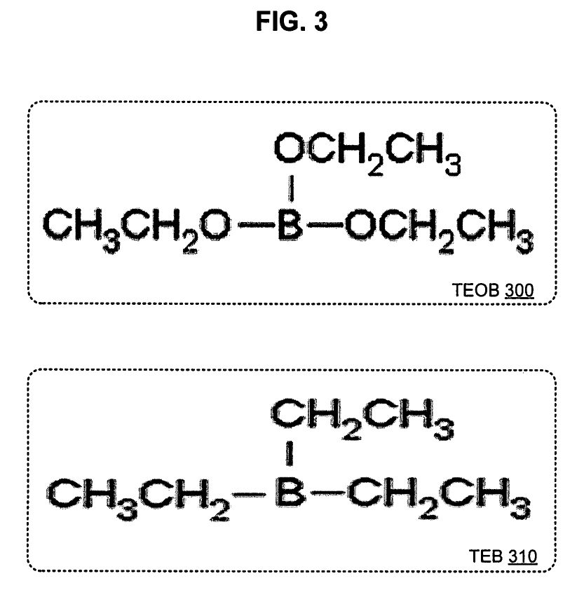

An embodiment incorporates alkyl- and alkoxyboranes such as triethoxyborane (TEOB) or triethylborane (TEB) as an additive to standard low-k CDO PECVD precursors such as DMDOS 200 or DEMS 210 shown in FIG. 2 to include boron to the CDO film, the benefits of which have been introduced above. The structure of TEOB 300 and TEB 310 are illustrated by FIG. 3. The TEOB 300 and TEB 310 precursors of an embodiment are of particular interest because they are liquids at room temperature with a boiling point of approximately 100° C. at 1 atmosphere pressure. Alkoxyboranes like TEOB are somewhat more commercially practicable than alkylboranes like TEB as some of the later are pyrophoric (i.e. they spontaneously ignite in air, increasing the difficulty with which the material can be used). The alkoxyboranes also contain boron bonded to three oxygen atoms which is the manner by which the boron of an embodiment will likely be assimilated into the CDO matrix as explained above. Further, if B₂O₃ were to precipitate out during the boron-doped CDO deposition step or during subsequent processing step, there would not be a significant increase to the dielectric constant of the resulting dielectric material as the intrinsic dielectric constant of B₂O₃ is at worst on the order of the dielectric constant of SiO₂.

In other embodiments, fluorine-containing additives lower the dielectric constant and/or increase the mechanical strength of CDO films. In an embodiment, terminal CF₃ (trifluoromethyl) groups in the CDO matrix in the place of methyl groups introduces porosity similar to that introduced by methyl groups and the polarizability of the C—F bond is lower than that of a C—H bond. The result is a lower dielectric constant for a given level of trifluoromethyl methyl group incorporation. In another embodiment, terminal F groups may be introduced into the CDO matrix in the place of methyl groups. In this embodiment, the F group occupies a smaller volume than a methyl group, creating porosity due to the matrix disruption caused by the F group, but keeping a higher overall bond density compared to a similar matrix with methyl groups present. Another embodiment may optimize the dielectric constant and mechanical properties of the CDO film by combining CH₃, F and CF₃ groups to take advantage of a combination of the individual terminal group features.

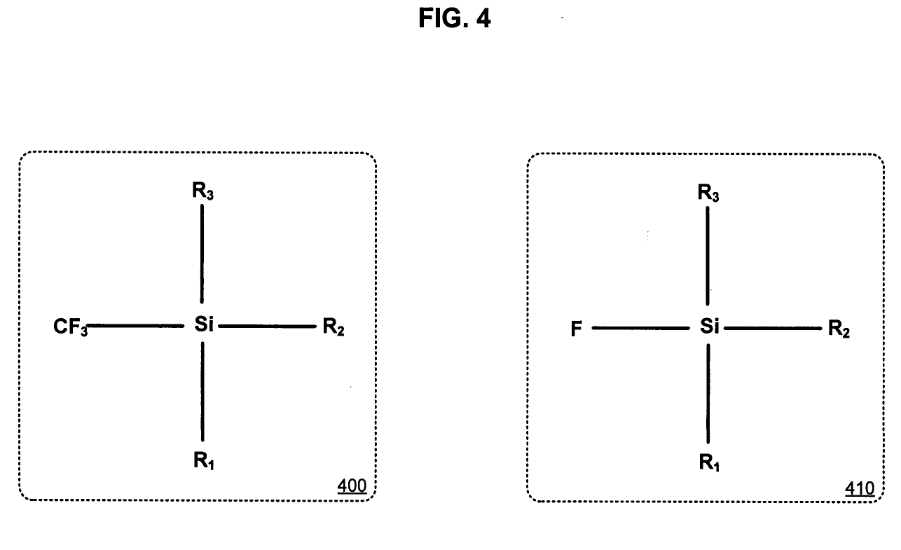

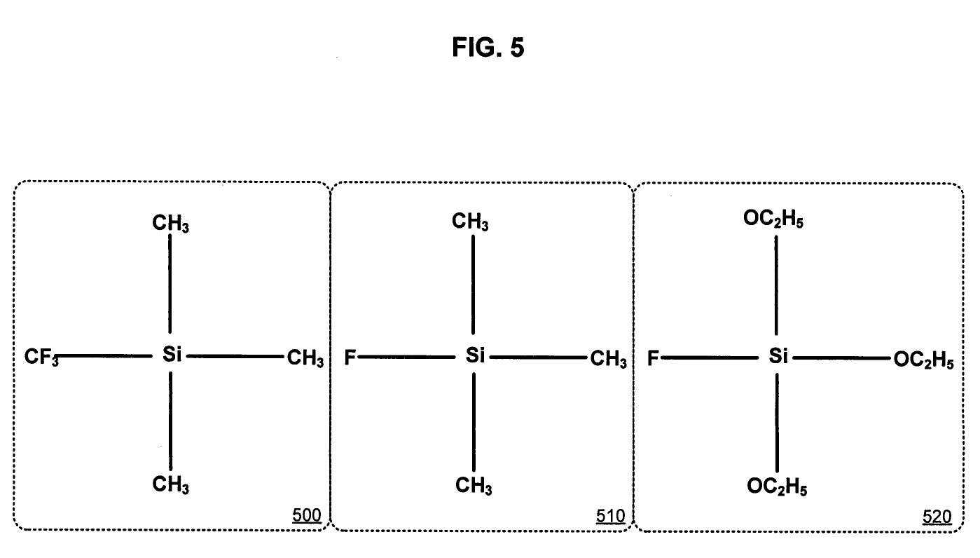

An embodiment includes a fluorinated organic silane precursor as an additive to standard low-k CDO precursors such as DMDMOS 200 or DEMS 210 shown in FIG. 2. The most general members of this class are shown in FIG. 4 with precursor 400 containing a CF₃ terminal group and precursor 410 containing a fluorine terminal group. Said differently, the fluorinated organic silane precursor contains a single or multiple silicon atoms with at least one fluorine and/or one CF₃ bonded thereto. The R-groups labeled R₁, R₂, and R₃ could be any organic terminal group such as CH₃, OCH₃, C₂H₅, and OC₂H₅, or further fluorine and CF₃ terminal groups. FIG. 5 illustrates precursor 500 (trifluoromethyltrimethylsilane), which includes a terminal CF₃ group and CH₃ for R₁-R₃, precursor 510 (fluorotrimethylsilane), which includes a terminal fluorine and CH₃ for R₁-R₃, and precursor 520 (fluorotriethoxysilane, also referred to as “FTES”), which includes a terminal fluorine and OC₂H₅ for R₁-R₃.

In another embodiment, both boron- and fluorine-doping may be used to simultaneously lower the dielectric constant of the film while providing increased mechanical properties. In this embodiment, a boron source such as TEOB and a fluorine sources such as FTES may be co-deposited with a traditional CDO precursor to form a film containing both fluorine and boron, thus providing the benefits of incorporating each type of additive.

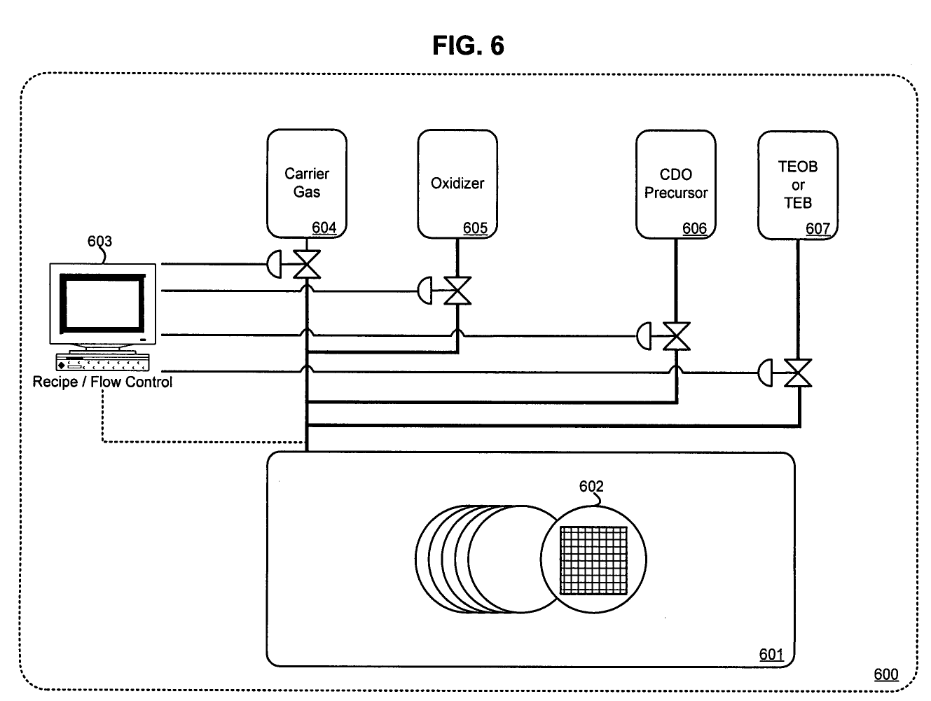

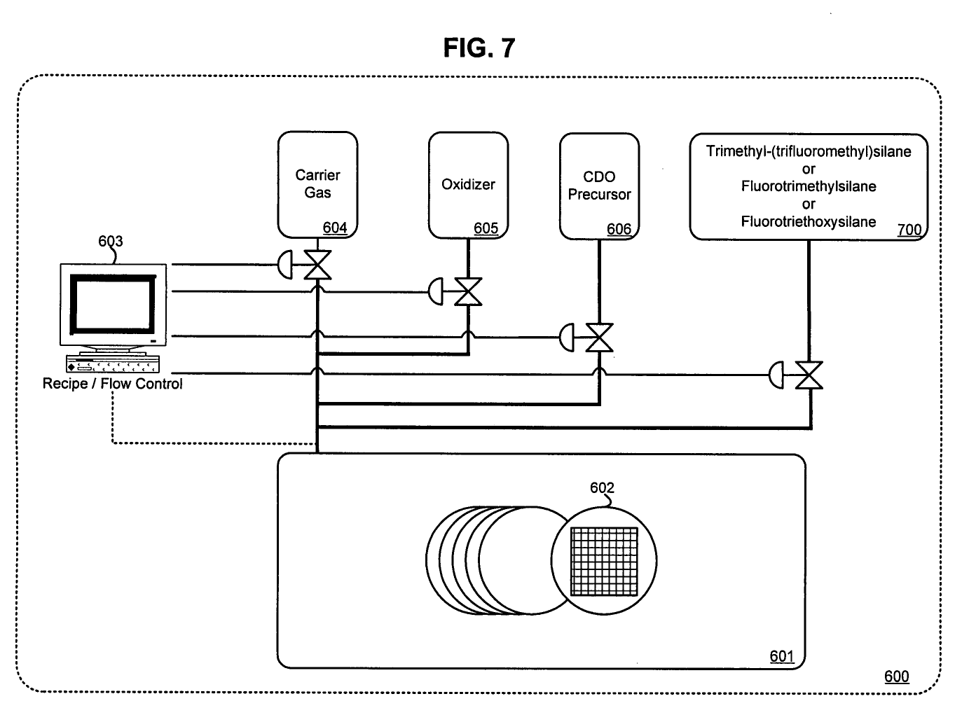

FIG. 6 illustrates an apparatus to deposit boron-doped CDO of an embodiment and FIG. 7 illustrates the same apparatus to deposit fluorine-doped CDO of an embodiment with a chemical vapor deposition system 600 (in which the vacuum and electrical sources have been omitted for simplicity). A deposition chamber 601 houses one or more wafers 602 during exposure. Recipe/flow control 603 controls the pressure and flow of the individual source gases to facilitate the additive-doped CDO deposition. In an embodiment, the chuck temperature (i.e., on which wafer 602 its) is approximately between 300° C. and 400° C. and the pressure in the deposition chamber is approximately between 500 and 1000 Pascal. In an embodiment, the chemical vapor deposition is plasma enhanced with an RF power of approximately between 250 and 3500 watts.

The precursor gases of a boron-doped CDO of an embodiment include a CDO precursor 606 (e.g., DMDMOS or DEMS), an additive precursor 607 (e.g., TEOB or TEB ), an optional oxidizer 605 (e.g., oxygen, water, or nitrous oxide) and a carrier gas 604 (e.g., helium or argon). For the fluorine-doped CDO of an embodiment, and as illustrated by FIG. 7, additive precursor 700 may be trimethyl-(trifluoromethyl)silane, fluortrimethylsilane, or fluorotriethoxysilane.

More specifically, for a boron-doped CDO embodiment, it is important that there is a minimum of at least one CH₃ group per silicon atom in the silicon-containing precursor. The ratio of flow rates of the CDO precursor gas and boron-containing additive gas can be described by the following relationship:

$$\frac{\begin{matrix}[ ( Flow of B \text{-} containing additive ) * \\ ( \# of B atoms per additive molecule ) ]\end{matrix}}{\begin{matrix}[ ( Flow of Si \text{-} containing precursor ) * \\ ( \# of Si atoms per precursor molecule ) ]\end{matrix}} = x$$

In the above relationship, 0<x<0.75. The flow rates may be adjusted to provide a final boron-doped CDO film composition that is up to approximately 8.0 atomic % CH₃ and up to approximately 8.0 atomic % boron (i.e., up to 16% combined CH₃ and boron).

For a fluorine-doped CDO of an embodiment, the ratio of flow rates of the CDO precursor gas and fluorine-containing additive gas can be described by the following relationship:

$$\frac{\begin{matrix}[ ( Flow of F \text{-} containing additive ) * \\ ( \# of F atoms per additive molecule ) ]\end{matrix}}{\begin{matrix}[ ( Flow of Si \text{-} containing precursor ) * \\ ( \# of Si atoms per precursor molecule ) ]\end{matrix}} = x$$

Similarly, the ratio of flow rates of the CDO precursor gas and CF₃-containing additive gas can be described by the following relationship:

$$\frac{\begin{matrix}[ ( Flow of {CF}_{3} \text{-} containing additive ) * \\ ( \# of {CF}_{3} atoms per additive molecule ) ]\end{matrix}}{\begin{matrix}[ ( Flow of Si \text{-} containing precursor ) * \\ ( \# of Si atoms per precursor molecule ) ]\end{matrix}} = x$$

The ratio of flow rates of the CDO precursor gas and a combination of fluorine and CF₃-containing additive gases can be described by the following relationship:

$$\frac{\begin{matrix}\begin{matrix}[ ( Flow of F \text{-} containing additive ) * \\ ( \# of F atoms per additive molecule ) ] +\end{matrix} \\ \begin{matrix}[ ( Flow of {CF}_{3} \text{-} containing additive ) * \\ ( \# of {CF}_{3} atoms per additive molecule ) ]\end{matrix}\end{matrix}}{\begin{matrix}[ ( Flow of Si \text{-} containing precursor ) * \\ ( \# of Si atoms per precursor molecule ) ]\end{matrix}} = x$$

For each of the above relationships, 0<x<0.75. It is to be understood that the above relationships refer only to the ratio of precursor gas flow rates and not the gas flow rates themselves. The resulting fluorine- and/or CF₃-doped CDO of an embodiment may have the following dopant combination compositions:

| | Approximate |
|---|---|
| Dopant(s) | Atomic % Range |
| CH₃ | 0-8% |
| F | 0-8% |
| CF₃ | 0-8% |
| CH₃ + F | 0-16% |
| CH₃ + CF₃ | 0-16% |
| CH₃ + CF₃ + F | 0-16% |

In an embodiment including a single fluorinated organic silane precursor (i.e., one that contains CH₃ and F and/or CF₃), the fluorinated organic silane precursor should contain at least one Si—CH₃ bond and at least one Si—F bond and/or at least one Si—CF₃ bond. Further, in an embodiment the fluorinated organic silane precursor also contains a Si—O—CH₃ bond and/or a Si—O—Si bond as a source of oxygen. For an embodiment utilizing a single fluorinated organic silane precursor that does not include oxygen, an external oxidizing additive such as O₂, N₂O, or other oxygen-containing additive may be used to provide sufficient oxygen to form the Si—O bonds in the CDO matrix.

It is to be further understood that for any embodiment, it is important that the precursor gas flow rates (or at least the ratio thereof) be substantially maintained during the entire deposition (i.e., not a step-wise deposition) to ensure a substantially uniformly doped CDO. The uniformity of the CDO in turn aids, among other features, the uniformity and predictability with which the doped CDO of embodiments may be etched.

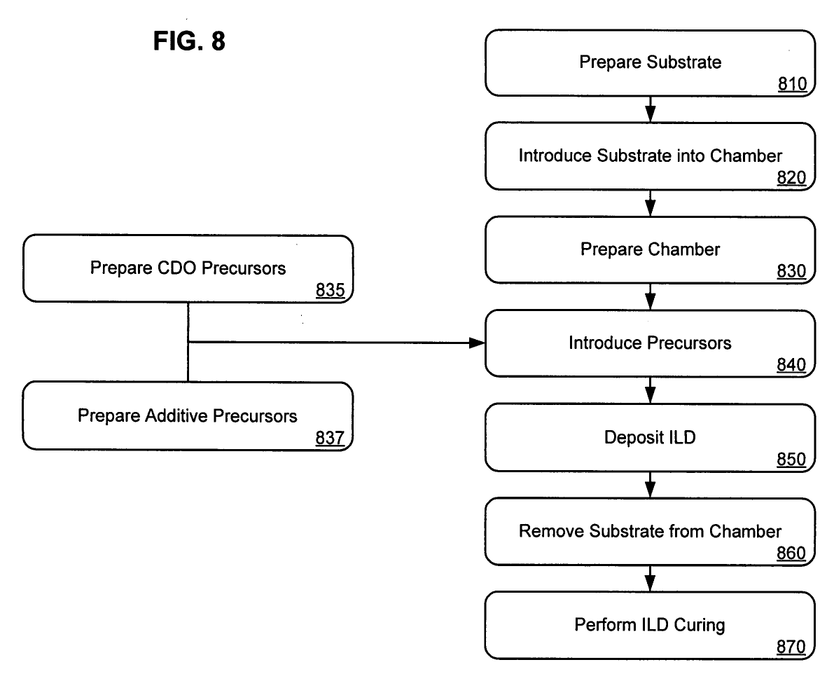

FIG. 8 illustrates the process flow of an embodiment for depositing a CDO film doped with boron- and/or fluorine-containing additives (or a combination thereof). At 810, the substrate first receives any needed preparatory treatment such as formation of preceding layers, etching, cleaning, or other actions as are specified for the particular device being formed, the deposition apparatus, or the user's preferred practices. The substrate is then placed into the deposition chamber, at 820, of the deposition apparatus. The deposition apparatus may be engineered for any of a number of deposition techniques, such as chemical vapor deposition (CVD), plasma-enhanced chemical vapor deposition (PECVD), atomic layer deposition (ALD), or thermal deposition.

The precursors may require preparation prior to introduction into the deposition chamber of the deposition apparatus. In various embodiments, the precursors may be in liquid or solid form under normal deposition conditions for a deposition apparatus and process and may require preparation at 835 for standard CDO precursors and/or at 837 for fluorine- or boron-containing additive precursors as would be appreciated by someone skilled in the art.

Once the chamber is sealed and the internal environment reaches specified conditions for the deposition process, at 830, the precursors are introduced into the deposition chamber, 840. In some embodiments of the invention, the introduction of the precursors may include introducing only a single additive precursor containing only fluorine or only boron in addition to the standard CDO precursors. In another embodiment, the introduction of the precursors may include introducing both fluorine-containing and boron-containing precursors in addition to the standard CDO precursors. Organic precursors acting as porogens may also be introduced to induce additional porosity in the CDO material, as would be appreciated by those skilled in the art. Examples of porogenic organic precursors may include alpha-terpinene, beta-terpinene, and D-limonene. An oxidizing agent such as oxygen, water or nitrous oxide may also be introduced into the deposition chamber at the same time as the precursors. In this case, the oxidizing agent can be considered a precursor, as it contributes oxygen to the structure of the deposited CDO.

At 850, the standard CDO precursors, additive precursor(s) and any optional porogens or oxidizers are then co-deposited onto the substrate. When the internal environment of the deposition chamber has reached deposition conditions, deposition will begin immediately upon introduction of the precursors into the chamber. The duration and other parameters of the deposition process will vary depending on the desired thickness of the deposited doped CDO layer and other considerations, as can be appreciated by one skilled in the art. The pressure within the deposition chamber may be set approximately between 10 and 10000 Pascal and in an embodiment between 500 and 1000 Pascal. The temperature in the deposition chamber may be set approximately between 150° C. and 500° C. and in an embodiment between 300° C. and 400° C. The deposition time (duration) of an embodiment is approximately between 30-300 seconds. In an embodiment utilizing using PECVD, the RF power is approximately between 250-3500 watts. Further, the RF frequency of an embodiment is approximately 13.5 megahertz or a harmonic thereof.

After completion of the deposition process, the substrate is removed from the deposition chamber, in 860. Additional processing, in 870, such as annealing or curing may be used to form additional bonds within the CDO film (thus increasing the mechanical properties) and/or to remove any remaining porogen introduced during deposition. The annealing or curing treatment may include exposure to heat, electron beam, or ultraviolet energies.

One skilled in the art will recognize the elegance of an embodiment as it increases the mechanical stability of a low dielectric constant CDO dielectric. Further, the simplicity with which the inorganic strengthening additive precursor gas or gases can be added to an existing CDO process flow emphasizes the in situ simplicity with which a strengthened low-k CDO can be formed.

What is claimed is:

1. A method comprising:
providing a carbon-doped silicon oxide (CDO) precursor;
providing a strengthening additive precursor; and
forming, with chemical vapor deposition including the CDO precursor and the strengthening additive precursor, a strengthened CDO.

2. The method of claim 1, the CDO precursor selected from the group consisting of dimethyldimethoxysilane and diethoxymethylsilane.

3. The method of claim 1, the strengthening additive precursor selected from the group consisting of a boron precursor, a fluorinated organic silane precursor, and a combination thereof.

4. The method of claim 3, the boron precursor selected from the group consisting of an alkylborane and an alkoxyborane, and a combination thereof.

5. The method of claim 3, the alkoxyborane selected from the group consisting of triethoxyborane and triethylborane.

6. The method of claim 3, the a fluorinated organic silane precursor selected from the group consisting of trimethyl-(trifluoromethyl)silane, fluorotrimethylsilane, and fluoro-triethoxysilane, and a combination thereof.

7. The method of claim 3, the strengthened CDO including up to approximately 8.0 atomic percent boron, up to approximately 8.0 atomic percent CH₃, up to approximately 8.0 atomic percent fluorine, up to approximately 8.0 atomic percent CF₃, and up to approximately 8.0 atomic percent CF₃.

8. A method comprising:
providing a carbon-doped silicon oxide (CDO) precursor;
providing one of a boron precursor, a fluorinated organic silane precursor, or a combination of boron and fluorinated organic silane precursors; and
forming, with chemical vapor deposition including the CDO precursor and one of the boron precursor, the fluorinated organic silane precursor, or the combination of boron and fluorinated organic silane precursors, a strengthened CDO.

9. The method of claim 8 wherein the ratio of the product of a boron precursor flow rate and number of boron atoms per boron precursor molecule to the product of a CDO precursor flow rate and number of silicon atoms per CDO precursor molecule is less than approximately 0.75.

10. The method of claim 8 wherein the ratio of the product of a fluorinated organic silane precursor flow rate and number of fluorine atoms per fluorinated organic silane precursor molecule to the product of a CDO precursor flow rate and number of silicon atoms per CDO precursor molecule is less than approximately 0.75

11. The method of claim 8 wherein the ratio of the product of a fluorinated organic silane precursor flow rate and number of CF₃ groups per fluorinated organic silane precursor molecule to the product of a CDO precursor flow rate and number of silicon atoms per CDO precursor molecule is less than approximately 0.75.

12. The method of claim 8 wherein the ratio of
a sum of
a product of a first fluorinated organic silane precursor flow rate and number of fluorine atoms per first fluorinated organic silane precursor molecule and
a product of a second fluorinated organic silane precursor flow rate and number of CF₃ groups per second fluorinated organic silane precursor molecule to the product of a CDO precursor flow rate and number of silicon atoms per CDO precursor molecule is less than approximately 0.75.

13. An apparatus comprising:
a carbon-doped oxide (CDO) including a strengthening additive wherein the strengthening additive is selected from the group consisting of boron, fluorine, a trifluoromethyl (CF₃) group, a methyl (CH₃) group, and a combination thereof.

14. The apparatus of claim 13, the CDO further comprising up to 8.0 atomic percent CH₃.

15. The apparatus of claim 14, the CDO further comprising up to 8.0 atomic percent boron.

16. The apparatus of claim 14, the CDO further comprising up to 8.0 atomic percent fluorine.

17. The apparatus of claim 14, the CDO further comprising up to 8.0 atomic percent CF₃.

18. The apparatus of claim 13, the CDO further comprising CH₃, CF₃, and fluorine wherein the sum of the CH₃, CF₃, and fluorine is less than or equal to 16.0 atomic percent.
